(19) United States
(12) Patent Application Publication
(10) Pub. No.: US 2004/0211073 A1
(43) Pub. Date: Oct. 28, 2004

(54) Apparatus and method for finding and identifying nighttime sky objects

(76) Inventor: Samuel Mason Curry, Menlo Park, CA (US)

Correspondence Address: Samuel Mason Curry, Apt. C107, 600 Sharon Park Dr., Menlo Park, CA, 94305, US

(21) Appl. No.: 10/734,974

(22) Filed: Dec. 15, 2003

Related U.S. Application Data
(60) Provisional application No. 60/433,241, filed on Feb. 27, 2003.

(51) Int. Cl. G01C 17/34

(52) U.S. Cl. 33/268

(57) ABSTRACT

Apparatus and methods for finding and identifying objects in a nighttime sky which includes templates which may represent the form of constellations and a means of holding said templates positioned to orient and identify the names of celestial bodies while looking at them. The present device is viewed simultaneously and directly in line with the stars, thus if two or three stars of the constellation are lined up, all of the stars will be lined up, including those stars too dim to be seen with the naked eye in the given light conditions. To compensate for the dome of the sky, only one area of the sky will be viewed at a time. Additionally, the present device allows the observer to see the lines connecting the stars to make up a given constellation, asterism, or other such grouping at the same time as the stars.

### BACKGROUND OF THE INVENTION

a) Field of the Invention

This invention relates in general to the field of astronomy and in particular to the field of locating and identifying stars, planets, and constellations by visual means.

b) Description of the Prior Art

Star gazing by non-professionals is an everyday occurrence. The nighttime sky is not only a thing of spectacular beauty; it holds the secrets to life itself. It is inconceivable that a person can look up into the nighttime sky and not shake his or her head in amazement. On a dark night, the view is without equal—it is truly galactic.

Unfortunately, most persons who view the heavens at nighttime simply do not know what they are seeing. The average person cannot locate the planets or the constellations. Some of the more fortunate few can identify and locate some of the more common stars, or planets, or constellations, such as the North Star, Mars, and the small and big dippers. To most persons, however, the sky is an unknown, albeit a spectacular unknown.

A general approach to understanding what a person is seeing when he or she views the nighttime sky is to obtain a basic book or chart of the stars. Then, if he or she can orient himself with relation to the sky and the illustrations in the book, he or she might be able to locate and identify particular stars, planets, and even constellations. “Might” is the key word because the average person, as hard as he or she may try, will often fail to identify and locate particular heavenly bodies. Even if successful, the average person will probably still be uncertain that he or she has actually found and is viewing the particular body sought. One of the problems being the varying location of the heavenly bodies at any particular time of day, or year. The location of some stars and constellations vary greatly over time, others not so much, and even others hardly at all. Another variable is the location of the stargazer. A view from Greenland is vastly different from the view at Panama, even on the same day and at the same time. When different seasons of the year are added to the situation, the identification and location process becomes extremely difficult. The nighttime sky is simply too vast and too variable for the average person.

The following patents of the prior art disclose similar devices to the present invention, yet are replete with deficiencies, as discussed below:

U.S. Pat. No. 3,863,365

U.S. Pat. No. 3,863,365 of Moliard discloses a method that uses a flat spinning disc that contains a pictorial representation of a celestial hemisphere containing constellations and stars. A user must rotate the disc to the current time and date, and then orient themselves with the proper compass direction. Identification of a celestial object is attempted by the user comparing the sky with the celestial hemisphere pictorial representation. This method proves rather difficult to locate a celestial object, in that the sky and the pictorial representation of the celestial hemisphere are two different scales. Additionally, the disc contains a flattened perspective of the celestial hemisphere making it difficult to judge at what angle of declination one would locate the desired celestial object. Further, the sky contains many more celestial objects than the pictorial representation can possibly contain, making it difficult to determine which pattern of stars on the pictorial representation corresponds to a particular region of the sky.

U.S. Pat. No. 4,938,697

U.S. Pat. No. 4,938,697 of Mayer discloses a somewhat clumsy and complicated mechanical device and method of directly observing a region of the sky without a map. It requires a good deal of understanding of the devices workings to obtain any success; in addition it can only locate a star-group or constellation.

U.S. Pat. No. 4,970,793

U.S. Pat. No. 4,970,793 of Atamian contains a method for location of stars and constellations, yet it requires manual alignment of a sphere oriented with the sky to work properly. It also has the same scale difference problem mentioned above that U.S. Pat. No. 3,863,365 that leaves much ambiguity in observing heavenly bodies.

U.S. Pat. No. 2,994,971

Another prior art approach to this is disclosed in U.S. Pat. No. 2,994,971 of Meisenheimer et al, in which a transparent plate is held up at arm's length and the constellations are viewed through the transparent plate. While this system has many merits, it, too, has many failings, which the present device improves upon. The device of prior art has no means of assisting in locating it relative to the viewer, and the transparent plates will inevitably reduce the amount of light reaching the observer, thus making the dimmer stars more difficult to see, especially near our busy cities. In addition, the stars are indicated on the transparent plates at the point they would be seen by the observer, resulting in obscuring the stars when the device is lined up properly. Furthermore, no allowance is made for fixing the prior art on a tripod or stand of some sort so that once the position is set, other people can come and see the constellation with no prior knowledge whatsoever of the night sky.

U.S. Pat. No. 6,056,554

A prior art approach to this is disclosed in U.S. Pat. No. 6,056,554 of Samole, in which an electronic device is used to locate or identify objects observed in the night sky. The observer holds this device under his line of sight rather than in line with the stars themselves. The user must compare what he or she sees to what is on the screen, but no direct confirmation of alignment exists. If the device runs out of battery power, it will no longer work, whereas the present invention uses much simpler physical and optical means.

U.S. Pat. Nos. 2,032,829; 6,028,721

U.S. Pat. Nos. 2,032,829 of Bartky and 6,028,721 of Gerritsen et al., both disclose stargazing devices which are designed to view a star map with one eye, while simultaneously viewing the sky with the other eye. This prior device does not provide a direct visual confirmation of the stars matching the map and the device cannot be used by people with a vision problem in one eye. The present invention allows the user direct visual sighting of the constellations and the device simultaneously and with one eye.

U.S. Pat. Nos. 5,003,698; 2,755,565; 5,704,653; Des. 267,958

Many star finder maps, books, charts, or planispheres are available such as those disclosed in U.S. Pat. No. 5,003,698 to Vuarnesson, U.S. Pat. No. 2,755,565 to Alkema, U.S. Pat. No. 5,704,653 to Lee, and Des. 267,958 to Watanabe. All of these devices are useful tools to begin to look for stars and constellations in the nighttime sky, but all require the observer to view the sky and the device separately. Thus the observer must shift his or her gaze back and forth between the device and the sky and attempt to determine which star in the sky matches each star on the chart. No direct visual identification is made of the stars. These devices also tend to be viewed at a scale much different from that of the actual sky and are often distorted to fit on a single flat page.

### SUMMARY OF THE INVENTION

Apparatus and methods for finding and identifying objects in a nighttime sky which includes templates which may represent the form of constellations and a means of holding said templates positioned to orient and identify the names of celestial bodies while looking at them. The present device is viewed simultaneously and directly in line with the stars, thus if two or three stars of the constellation are lined up, all of the stars will be lined up, including those stars too dim to be seen with the naked eye in the given light conditions. To compensate for the dome of the sky, only one area of the sky will be viewed at a time. Additionally, the present device allows the observer to see the lines connecting the stars to make up a given constellation, asterism, or other such grouping at the same time as the stars.

### OBJECTS AND ADVANTAGES

A first object of the present invention is to provide an apparatus and methods for use by an average person so as to enable the average person to easily and quickly identify and locate stars, constellations, and other nighttime objects, with direct and simultaneous viewing of the apparatus and the nighttime objects.

Another object of the invention is to provide means to orient and identify the names of celestial bodies while looking at them, which avoid the necessity of diverting one's gaze from the sky region that is under observation in order to consult opaque charts, diagrams, or the like, located apart from the line of vision when viewing the sky.

The invention is to allow the stars and other nighttime objects to be seen with the naked eye simultaneously with the device.

The invention is to minimize the reduction of light from the stars to allow maximum visibility. The invention is to allow lines connecting the stars, which may form constellations, asterisms, or general guidance to be seen simultaneously with the stars and the portion of the device locating the stars.

The invention is to provide the observer guidance to the proper orientation of the device.

The invention is to provide the observer guidance to locate the templates the proper distance from the eye.

Another object is to provide means of illuminating the templates when desired.

Another object is to construct a star finder of the aforementioned kind that can be carried easily outdoors.

Another object is to construct a star finder of the aforementioned kind that can be used while either mounted on a stand or held in a hand.

Another object is to be usable by young children as well as adults.

The above-stated objects as well as other objects which, although not specifically stated, but are intended to be included within the scope of the present invention, are accomplished by the present invention and will become apparent from the hereinafter set forth Detailed Description of the Invention, Drawings, and the claims appended herewith.

### BRIEF DESCRIPTION OF THE DRAWINGS

FIG. 1 is a view of the usage of one embodiment of the apparatus.

FIG. 2 is the plan view of a typical constellation template of one type, in this case, the constellation Leo.

FIG. 3 is the plan view of a typical constellation template of one type, in this case, including the constellations Ursa Major and Ursa Minor.

FIG. 4 and FIG. 5 are an isometric view of one embodiment of the handle portion of the apparatus.

FIG. 6 and FIG. 7 are view of the usage of a second embodiment of the apparatus.

### DETAILED DESCRIPTION OF THE PREFERRED EMBODIMENTS

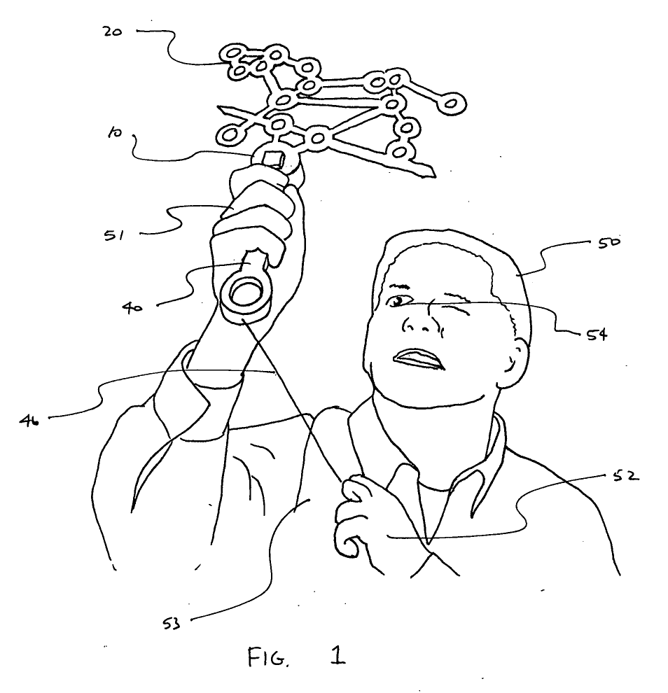

FIG. 1 illustrates the method of use of one embodiment of the invention. The user 50 holds the handle 40 with one hand 51 and can use the string 43 by holding, with the other hand 52, the knob 44 at the end of the string 43 to his or her chest or shoulder 53 and pulling the handle 40 until the string 43 is taut. The user 50 may then look with one eye 54 thru the template 10 and, when lined up properly, the user 50 will see the intended stars thru the holes 11 in the template 10. Without a clear, dark sky, it is possible that not all of the stars will be visible.

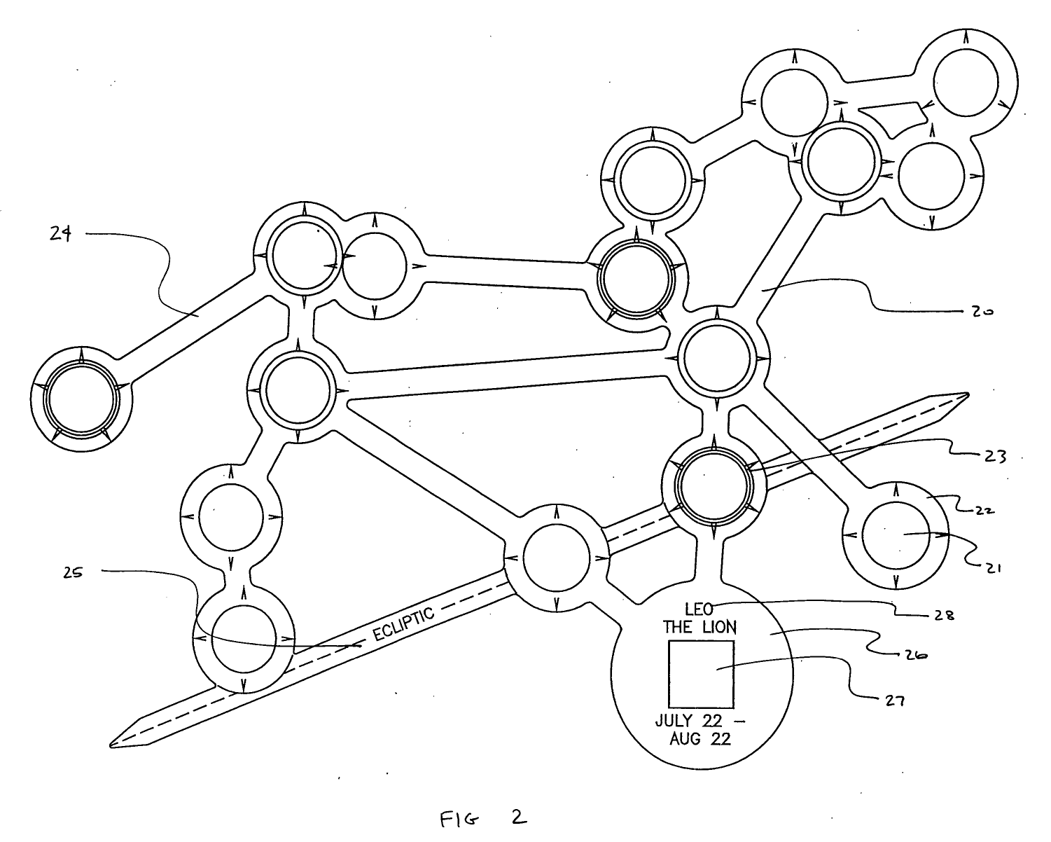

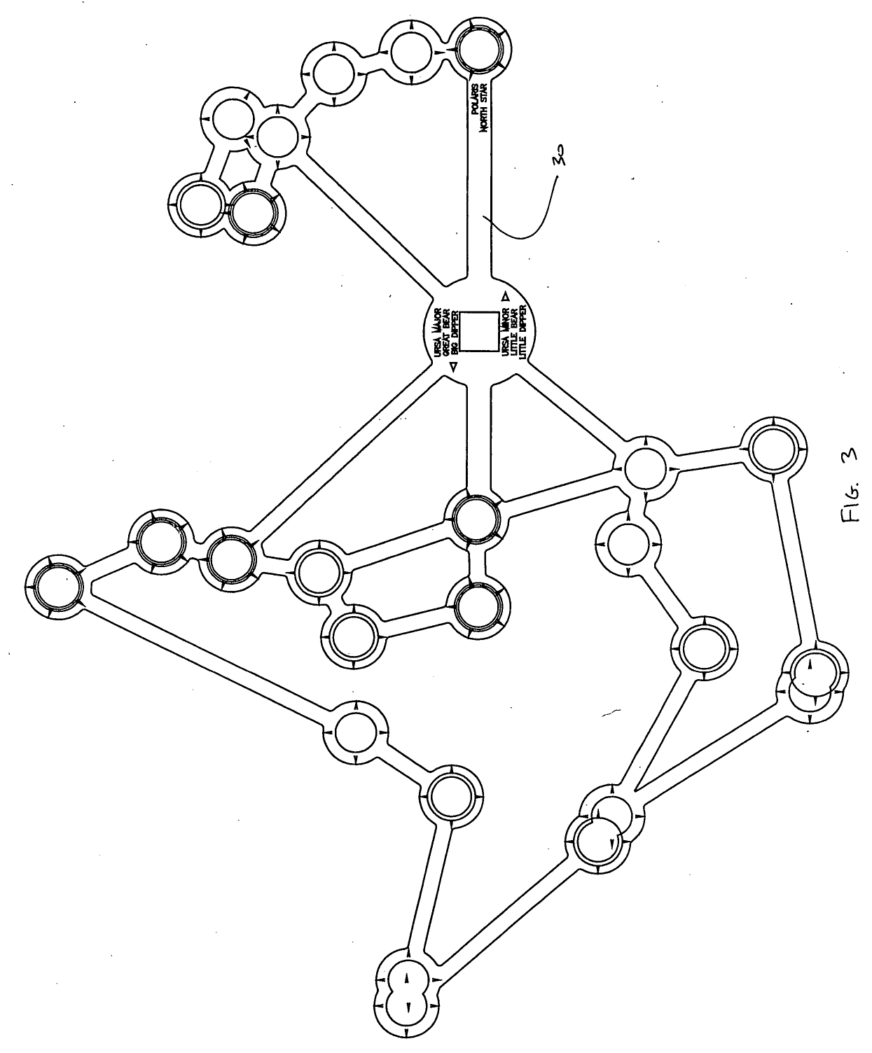

FIG. 2 and FIG. 3. illustrate a plan view of typical constellation templates 10. Said templates 10 consist of an opening 11 for each star or group stars. The use of the word star is meant to include any heavenly body, including, but not limited to galaxies, nebulae, Messier objects, and satellites. Around each opening 11 is a ring 12, which may be circular or any shape deemed appropriate. On each ring 12 may be an indication 13 of information about the star. Said indication 13 may be graphics, color, text, size, shape or any method deemed appropriate to convey the information. Said information may include, but is not limited to the object's name, magnitude or brightness, type of object, and distance to said object. Between each star ring 12, is a connecting line 14 which may indicate one method of connecting the stars in the form of a constellation, asterism, or other grouping. The template 10 may also include an indication 15 of other sky information. The indication 15 in the template 10 shown in FIG. 1 is for the ecliptic, the apparent path of the sun thru the sky. The template 10 may include a base 16. This base may have a means of attachment 17 to a number of embodiments of handles, two of which are shown in the FIGS. 1, 4, 5, 6, and 7. This means of attachment 17 may be of a shape or type such that the orientation of the template 10 to the handle is limited. The template 10 may also include information 18 about the constellation.

FIG. 2 illustrates the constellation Leo. The template in FIG. 3 includes the constellations of Ursa Minor, also known as the Little Dipper, and Ursa Major, which includes the asterism known as the Big Dipper. These are just two examples of possible constellations. Many others and different forms of these are intended to be covered by this patent.

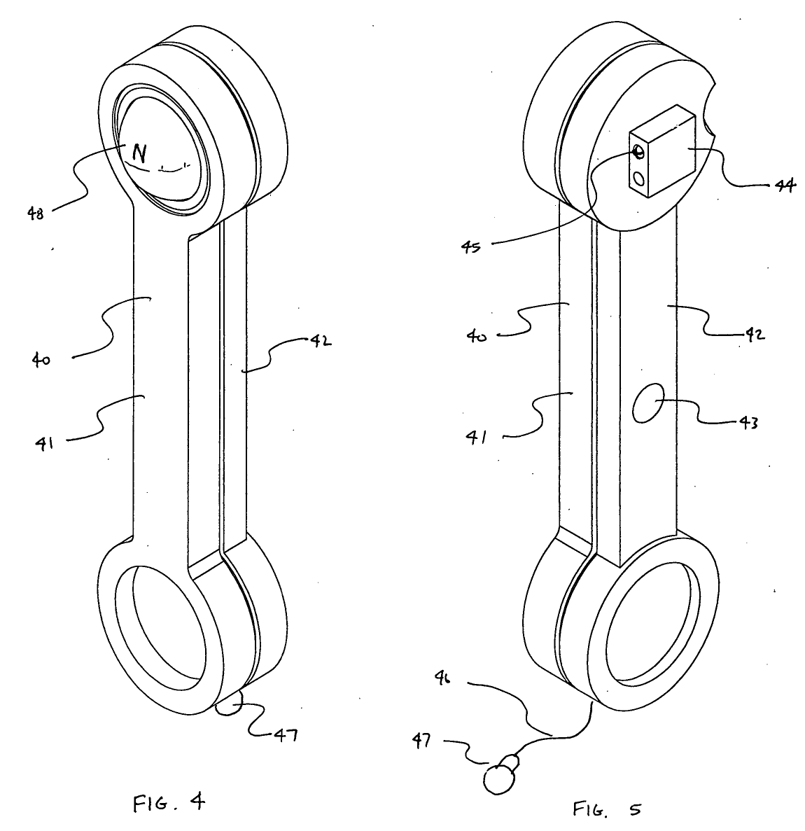

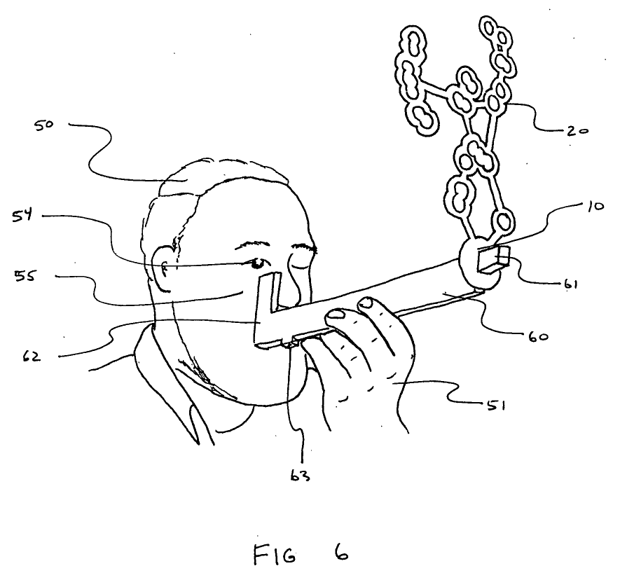

FIG. 4 and FIG. 5 show isometric views of one embodiment of the handle 40. The handle 40 will include an attachment point 41 that attaches the means of attachment 17 on the base 16 of the template 10 to the handle 40. The template 10 may be held in place by various means. The mechanism used in this embodiment is shown as a spring loaded ball plunger 42, but many common mechanisms and methods may be used and it is not the intention to limit the possible methods. The handle 40 may include a means of indicating the distance for the user to hold the template 10 away from his or her eye. In this embodiment, there is a string 43 with a knob 44 on the end, which makes the string 43 easier to hold. This string 43 may be retractable into the body of the handle 40 or it may be a fixed length. A possible means of retracting the string 43 is a spring-loaded reel, which holds the string 43 in the handle 40 until it is pulled by the user. The handle 40 may also include a compass 45 and/or inclinometer 45. The handle 40 may also include a clock and a GPS receiver and display.

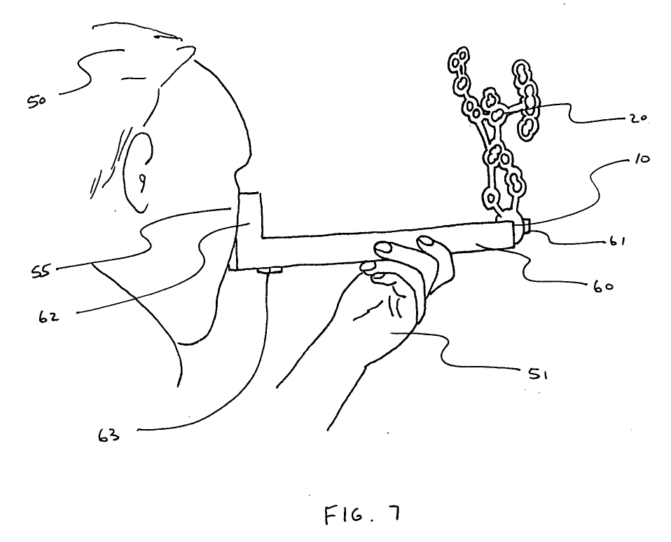

FIG. 6 and FIG. 7 show one method of use of a second embodiment of the invention. In this embodiment, the template 10 is attached to the handle 60 at the attachment point 61. The length of the handle 60 specifies the distance the template 10 should be held from the user's eye 54. The user 50 holds the handle 60 with one hand 51 or two hands, and holds the handle 60 such that the eyepiece 62 rests upon the user's cheek 55 just below the user's eye 54 and line of sight. Alternate styles of eyepieces 62 may also be employed. The handle 60 may also include a mounting point 63 for mounting the handle 60 to a stand, possibly a tripod. This mounting point 63 may consist of female threads such that the handle 60 may be mounted on a standard tripod.

To use the present device in one embodiment, a user will determine, through any number of means, which area of the sky a chosen constellation (meaning any grouping) of stars (or any nighttime objects) can be found. The user will chose the appropriate template 10, and attach it to the handle 40. Holding the handle 40 with one hand 51, the user pulls the knob 44 until the string 43 is tight. Holding the knob 44 to the user's chest or shoulder area and the string 43 tight will put the handle 40, and thus the template 10, the proper distance from the user's eye 54. Holding the template 10 perpendicular to the user's line of sight, the user holds the template 10 toward the area of the sky in which the constellation is located, and oriented in the same orientation as the constellation. Using two or three brighter stars in the grouping, the user locates the template 10 such that each star falls in line with the proper opening. When the template is aligned properly with these stars, all of the stars in the constellation will be aligned, and the user will then have direct visual confirmation of the finding of the stars. By seeing the template in line and simultaneously with the stars, the user can then have a lasting visual impression of what the constellation looks like, allowing it to be found much easier in the future.

In another embodiment, a user will attach the template 10 to the handle 60. In this embodiment, the length of the handle 60 indicates the distance the template 10 is to be held from the user's eye 54. The user will determine, through any number of means, which area of the sky the chosen constellation (meaning any grouping) of stars (or any nighttime objects) can be found. In this embodiment and method, the user attaches the handle 60 to a tripod at the mounting point 63. With his or her eye 54 aligned to the eyepiece 62 and looking thru the template 10, the user adjusts the handle 60 by moving the tripod head. The user points the template 10 toward the area of the sky in which the constellation is located, with the template 10 oriented in the same orientation as the constellation. Using two or three brighter stars in the grouping, the user locates the template 10 such that each star falls in line with the proper opening. When the template is aligned properly with these stars, all of the stars in the constellation will be aligned, and the user will then have direct visual confirmation of the finding of the stars. By seeing the template in line and simultaneously with the stars, the user can then have a lasting visual impression of what the constellation looks like, allowing it to be found much easier in the future. When the handle 60 is mounted on a tripod, or other appropriate stand, the first user may then leave the device set up so that a plurality of users, may look at the constellation and template 10 without going thru the process of finding and aligning the template 10 and constellation, and without any previous knowledge of the night sky.

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various figures are designated by the same reference numerals.

FIG. 1 depicts one embodiment of the inventive apparatus 10, which, as stated above, is characterized as a starfinder. FIG. 1 illustrates one use of the starfinder incorporating the invention wherein an observer holds the base 11, such that the eyepiece 12 rest on the observers cheek 15 with the eyepiece 12 below the observer's eye 16. Any one of a plurality of templates 13 removably attaches to the attachment point 14 of the base 11 such that the template is held firmly in a position a fixed distance from the eyepiece 12 and on a plane perpendicular to the length of the base 11.

Alternately, the base 11 may be removably attached to a tripod rather than being held by the observer.

While this base 20 is helpful and allows improved usability of the templates 13, the templates may themselves be held in a plurality of methods and still provide the primary functionality of viewing and identifying nighttime objects.

FIG. 2 shows an example of one embodiment of a constellation template 20, in this case for the constellation Orion. When used properly, the observer will see the selected nighttime objects through the holes 21 of the template. Each hole 21 will line up with one or more nighttime objects, and all of the holes 21 will line up with the nighttime objects simultaneously. The ring 22 around each hole 21 may indicate the brightness, or magnitude, and identity of the associated nighttime object. Methods of identification may include, but are not limited to, color, hole size, ring size, text, or graphics. The lines 23 between the rings 22 may indicate geometric relations between different nighttime objects, such as how the stars in a constellation may be graphically connected or how to find nighttime objects relative to others whose position has been found.

The template base 24 may have an attachment slot 25 which will removably attach to the attachment point of a base. The templates may be made of an appropriate material, such that the template will not deviate from the plane of the mounting point by a significant amount. This material may be wood, metal, plastic, stiff paper, or any other material that is deemed acceptable.

FIG. 3 depicts another embodiment of the apparatus. In this embodiment, the observer looks at the night sky through the improved starfinder held at approximately arm's length. This length is determined by a string 43, which may be retractable into the handle. This string is held to the user's body to indicate the distance from the body that the device should be held.

While the invention has been described, disclosed, illustrated, and shown in certain terms or certain embodiments or modifications which it has assumed in practice, the scope of the invention is not intended to be nor should it be deemed to be limited thereby and such other modifications or embodiments as may be suggested by the teachings herein are particularly reserved especially as they fall within the breadth and scope of the claims here appended.

I claim:

1. A star finder, comprising:
a body having a shape that is suitable to be carried in the hand of a user, said body having a template-receiving end;
a template having a securing opening at a first end, said securing opening being sized and shaped to snugly receive said body at said template-receiving end, said template further including at least two viewing openings that are oriented in such a manner to align specific known and predetermined celestial bodies with the user's eye so that the user may benefit in locating such celestial bodies in the night sky.
